(19) United States
(12) Patent Application Publication
(10) Pub. No.: US 2012/0252463 A1
(43) Pub. Date: Oct. 4, 2012

(54) METHOD FOR DETERMINING A LOCATION OF A MOBILE UNIT USING A SYSTEM REFERENCE TIME MAINTAINED BY THE MOBILE UNIT

(76) Inventors: Jialin Zou, Randolph, NJ (US); Subramanian Vasudevan, Morristown, NJ (US)

(21) Appl. No.: 13/075,364

(22) Filed: Mar. 30, 2011

(51) Int. Cl. H04W 64/00; H04W 36/32

(52) U.S. Cl. 455/441; 455/456.6

(57) ABSTRACT

The present invention provides a method of determining the location of a mobile node. Embodiments of the method may include comparing, at the mobile node, a local timing reference maintained by the mobile node to arrival times of signals transmitted by two or more base stations to determine two or more distances between the mobile node and the base stations. Embodiments of the method may also include determining, at the mobile node, a location of the mobile node using the distances and locations of the base stations.

### BACKGROUND

1. Field of the Invention

This invention relates generally to communication systems, and, more particularly, to wireless communication systems.

2. Description of the Related Art

A conventional communication system uses one or more access nodes to provide network connectivity to one or more mobile nodes. The access nodes may be referred to as access points, access networks, base stations, base station routers, cells, macrocells, microcells, femtocells, pico-cells, and the like. For example, in a cellular communication system that operates according to Universal Mobile Telecommunication Services (UMTS) standards, one or more nodes may be used to provide wireless network connectivity to mobile nodes. The mobile nodes may include cellular telephones, personal data assistants, smart phones, text messaging devices, Global Positioning Systems, navigation systems, network interface cards, notebook computers, desktop computers, and the like. Numerous types and generations of wireless communication systems have been developed and deployed to provide network connectivity to mobile nodes. Exemplary wireless communication systems include systems that provide wireless connectivity to micro cells (e.g., systems that provide wireless connectivity according to the IEEE 802.11, IEEE 802.15, or Wi-Fi standards) and systems that provide wireless connectivity to macro cells (e.g., systems that operate according to the Third Generation Partnership Project standards—3GPP, 3GPP2—and/or systems operate according to the IEEE 802.16 and IEEE 802.20 standards). Multiple generations of these systems have been deployed including Second Generation (2G), Third

Generation (3G), and Forth Generation (4G) standards.

The coverage provided by different service providers in a heterogeneous communication system may intersect and/or overlap. For example, a wireless access node for a wireless local area network may provide network connectivity to mobile nodes in a microcell or pico-cell associated with a coffee shop that is within the macrocell coverage area associated with a base station of a cellular communication system. For another example, cellular telephone coverage from multiple service providers may overlap and mobile nodes may therefore be able to access the wireless communication system using different generations of radio access technologies, e.g., when one service provider implements a 3G system and another service provider implements a 4G system. For yet another example, a single service provider may provide coverage using overlaying radio access technologies, e.g., when the service provider has deployed a 3G system and is in the process of incrementally upgrading to a 4G system.

Service providers and/or third parties support numerous applications and services that use the location and/or the speed of the mobile node. Mobile nodes that operate according to existing standards estimate their speed by counting the number of handovers between different cells. This approach consumes a relatively low amount of overhead and processing resources, but it provides a very inaccurate estimate of the speed of the mobile node that limits the functionality of the mobile node.

FIG. 1 conceptually illustrates a conventional wireless communication system 100. In the illustrated embodiment, mobile nodes 105, 110 are moving to the wireless communication system 100 at substantially the same speed along parallel paths 115, 120. Both of the mobile nodes 105, 110 are configured to estimate their speed by counting the number of handovers between the cells 125. During a time interval used to calculate the speed, the mobile node 105 crosses 5 different cell boundaries as it travels along the path 115. In contrast, the mobile node 110 only crosses two cell boundaries during the same time interval as it travels along the path 120. Consequently, the mobile node 105 estimates its speed to be more than twice the speed of the mobile node 110, even though the mobile nodes 105, 110 are traveling at substantially the same speed. Estimating the speed in the manner depicted in the illustrated embodiment also assumes that the cells 125 have the substantially the same shape and size, which is assumed to remain constant in time. This assumption rarely (if ever) holds true in an actual wireless communication system. Moreover, the sizes of the macrocells and microcells in heterogeneous networks are expected to differ by orders of magnitude, which would further degrade the accuracy of the conventional technique for estimating the speed of the mobile nodes 105, 110.

The low accuracy of the speed estimation limits the functionality of the mobile node. For example, the 3GPP Long Term Evolution (LTE) standards only define high, medium, low speeds and a scaling factor is defined for each level or category respectively at least in part because of the low accuracy of the technique for determining the speed of the mobile node. In systems that operate according to LTE, a speed or velocity of the mobile node can be used to determine scaling factors for scaling the hysteresis parameters used when the mobile nodes hand off between cells. Mobile nodes in the different speed categories multiply their hysteresis parameters by different scaling factors. For example, for high speed mobile nodes, performing faster handovers to avoid handover failures is a primary concern and ping-ponging of the mobile node between cells is a secondary concern and so handover sensitivity should be increased for high speed mobile nodes. The scaling factor therefore makes the hysteresis parameter smaller for higher speed mobile nodes. In contrast, ping-ponging is a primary concern for slower moving mobile nodes (and faster handovers may be a secondary concern) so the handover sensitivity may be decreased for slower moving mobile nodes. The scaling factor for the slower categories makes the hysteresis parameter larger for lower speed mobile nodes. However, the coarse division of mobile nodes into only three categories limits the ability of the system to adapt to variations in the speed of the mobile node.

Improving the accuracy of the estimated speed of mobile nodes typically incurs high costs in the form of increased overhead and/or increased power consumption within the mobile node. For example, mobile nodes may be equipped with global positioning system (GPS) functionality that can be used to determine the location of a mobile node to high accuracy. However, each location determination requires powering up the GPS in the mobile node, acquiring signals from several GPS satellites, and then performing the location calculation based on the received satellite signals. The GPS functionality consumes a significant amount of battery power to perform each location determination and overall power consumption may become prohibitive when frequent location estimations are performed. For example, the battery capacity in a mobile node may not be sufficient to support the frequent location estimation sampling that would be needed to estimate the velocity of the mobile node using the GPS functionality.

Location estimation may also be performed using measurements of radio signals transmitted between mobile nodes and base stations in the wireless communication system.

For example, the network can estimate the location of a mobile node using trilateration and/or triangulation based on measurements of an observed time difference of arrival (OTDOA) or an uplink time difference of arrival (UTDOA) for signals transmitted from the mobile node to base stations in the network. However, the air interface overhead required to support frequent location estimation may be prohibitive. For example, frequent location estimation will increase the measurement reporting overhead needed to transport the accurate raw data from mobile nodes to the network to support network-side trilateration calculations. Frequent location determinations will also increase the network backhaul traffic required to deliver measurement results from base stations to a central network entity (such as a radio network controller) that performs the triangulation calculations on the network side. For example, the network requires measurement information from at least three base stations to estimate the location of each mobile node. Consequently, significant complexity and processing power are required at the network to estimate the locations of a large population of mobile nodes. Moreover, many applications require that the mobile node know its location and/or speed. Consequently, the network may have to deliver the location and/or speed information to each mobile node over the air interface, thereby additionally increasing overhead.

Network-side location determination techniques are further complicated by requiring communication pathways over the air interface. Active mobile nodes may have a connection to the network that allows the mobile node to provide measurement reports to the network.

The active connection also allows the network to report the location and/or speed information back to the mobile node. However, idle mobile nodes do not have an active connection and so they cannot deliver the information that the network needs to estimate the location and/or speed of the idle mobile node. Furthermore, even if the network acquires this information, the network would have to locate and wake the mobile node to return the location and/or speed information to the idle mobile node.

### SUMMARY OF EMBODIMENTS OF THE INVENTION

The disclosed subject matter is directed to addressing the effects of one or more of the problems set forth above. The following presents a simplified summary of the disclosed subject matter in order to provide a basic understanding of some aspects of the disclosed subject matter. This summary is not an exhaustive overview of the disclosed subject matter.

It is not intended to identify key or critical elements of the disclosed subject matter or to delineate the scope of the disclosed subject matter. Its sole purpose is to present some concepts in a simplified form as a prelude to the more detailed description that is discussed later.

In one embodiment, a method is provided for determining the location of a mobile node. Embodiments of the method may include comparing, at the mobile node, a local timing reference maintained by the mobile node to arrival times of signals transmitted by two or more base stations to determine two or more distances between the mobile node and the base stations. Embodiments of the method may also include determining, at the mobile node, a location of the mobile node using the distances and locations of the base stations.

In another embodiment, a method is provided for supporting mobile node location determinations. Embodiments of the method may include providing, from a base station in response to a request from a mobile node, a timing offset defined to synchronize a local timing reference maintained by the mobile node to a global timing reference used to transmit signals from the base station. The mobile node is configured to compare the local timing reference to arrival times of signals transmitted by the base station and one or more other base station to determine distances between the mobile node and the base stations and thereby determine a location of the mobile node using the distances and locations of the base stations.

In yet another embodiment, a method is provided for determining the location of a femtocell. Embodiments of the method may include storing, at a femtocell, information indicating the location of the femtocell. The information is determined by a mobile node in response to the mobile node determining that a signal strength transmitted by the femtocell is above a predetermined threshold. The location of the femtocell is determined by a location determined by the mobile node using locations of base stations and distances between the mobile node and the base stations. The distances are determined by comparing, at the mobile node, a local timing reference maintained by the mobile node to arrival times of signals transmitted by the base stations.

### BRIEF DESCRIPTION OF THE DRAWINGS

The disclosed subject matter may be understood by reference to the following description taken in conjunction with the accompanying drawings, in which like reference numerals identify like elements, and in which:

FIG. 1 conceptually illustrates a conventional wireless communication system;

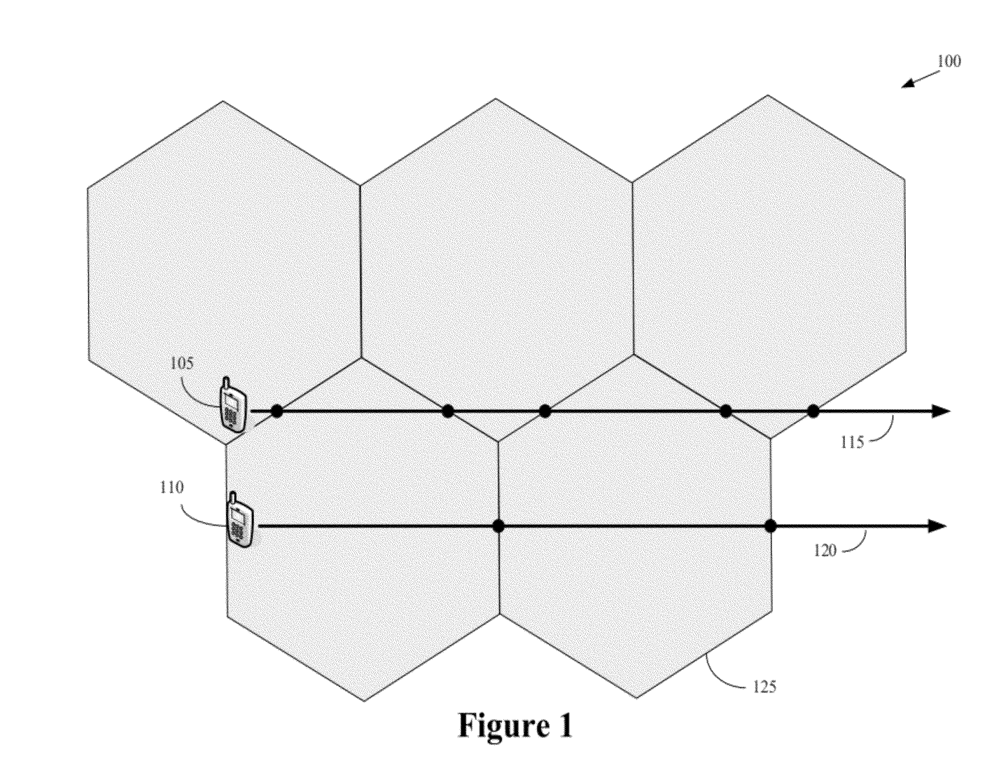

FIG. 2 conceptually illustrates a first exemplary embodiment of a wireless communication system;

FIG. 3 conceptually illustrates a second exemplary embodiment of a wireless communication system;

FIG. 4 conceptually illustrates one exemplary embodiment of a timing diagram;

FIG. 5 conceptually illustrates one exemplary embodiment of a method for determining a location of a mobile node;

FIG. 6 conceptually illustrates a third exemplary embodiment of a wireless communication system;

FIG. 7 conceptually illustrates a fourth exemplary embodiment of a wireless communication system; and

FIG. 8 conceptually illustrates a fifth exemplary embodiment of a wireless communication system.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the appended claims.

### DETAILED DESCRIPTION OF SPECIFIC EMBODIMENTS

Illustrative embodiments are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The disclosed subject matter will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

Generally, the present application describes embodiments of techniques that allow a mobile node to determine its location using an internal system timing reference signal/clock that is synchronized to a global system timing reference with substantially zero timing offset. The mobile node can measure the delay between the internal system timing reference and the arrival times of signals transmitted by neighboring base stations. Since the internal system timing reference is synchronized to the global system timing reference that is used to coordinate transmissions from the base stations, the measured delays are approximately equal to the distance between the mobile node and the transmitting base station divided by the signal propagation speed. The locations of the neighboring base stations can be provided to the mobile node, which is then able to calculate its location using the delays and locations of at least two neighboring base stations, e.g., using trilateration and/or triangulation. Embodiments of this technique can provide accurate location determinations at a significantly reduced overhead and power consumption compared to conventional location determination techniques. For example, the mobile node can determine its location without powering up a GPS system or exchanging messages with the network, except for relatively infrequent synchronization messages and/or messages that may be used to convey the locations of the neighboring base stations to the mobile node.

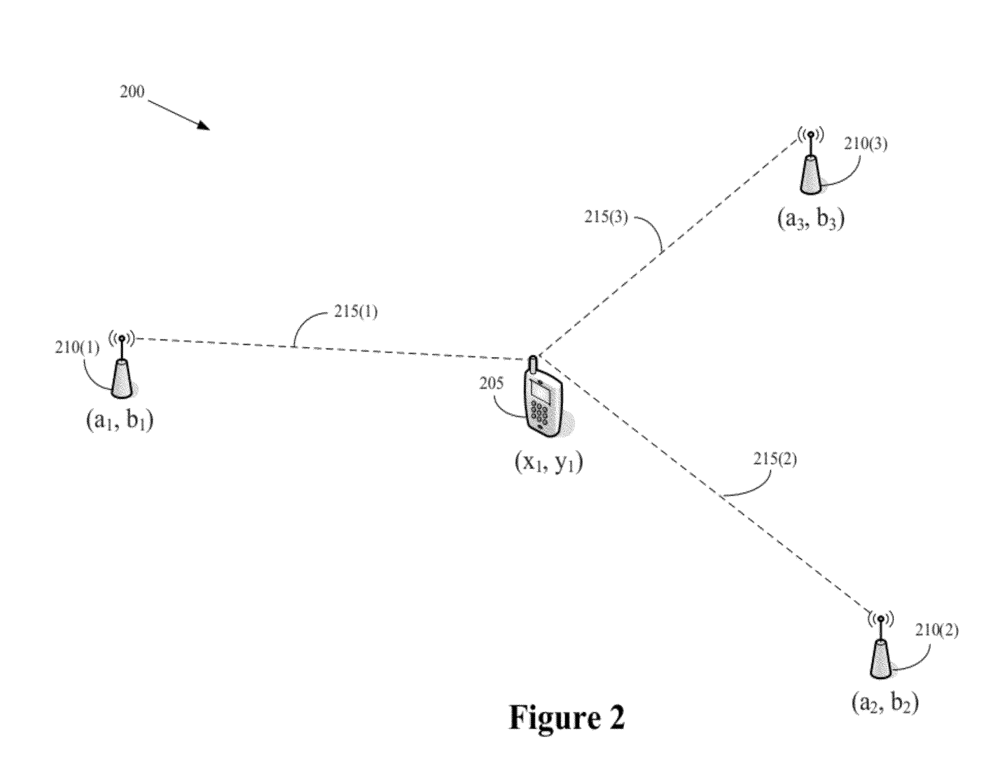

FIG. 2 conceptually illustrates a first exemplary embodiment of a wireless communication system 200. In the illustrated embodiment, a mobile node 205 is configured to communicate with one or more base stations 210 by exchanging radiofrequency signals over an air interface. The mobile node 205 and the base stations 210 may communicate according to agreed upon standards and/or protocols, such as the standards and/or protocols defined by 3GPP, IEEE, or other standards bodies. Techniques for communicating over air interfaces are well known and in the interest of clarity only those aspects of wireless communication that are relevant to the claimed subject matter will be discussed herein. The base stations 210 maintain a global timing reference that can be used to coordinate signal transmission and/or reception throughout the wireless communication system 200. For example, the base stations 210 may be synchronized to a GPS global timing reference or some other global timing reference.

In the illustrated embodiment, the mobile node 205 includes an internal clock that is synchronized to the global timing reference at selected intervals. For example, the internal clock may be synchronized to the global timing reference so that the internal clock represents a locally-maintained global system timing reference signal with substantially zero offset. As used herein, the term “substantially zero offset” is intended to indicate that the locally-maintained global system timing reference signal is synchronized to the global timing reference within a selected tolerance. For example, the locally-maintained global system timing reference signal may drift over time but may remain synchronized to within a tolerance determined by a target or maximum value of a distance measurement error that may result from a difference between the locally-maintained global timing reference signal and the global timing reference, as discussed herein.

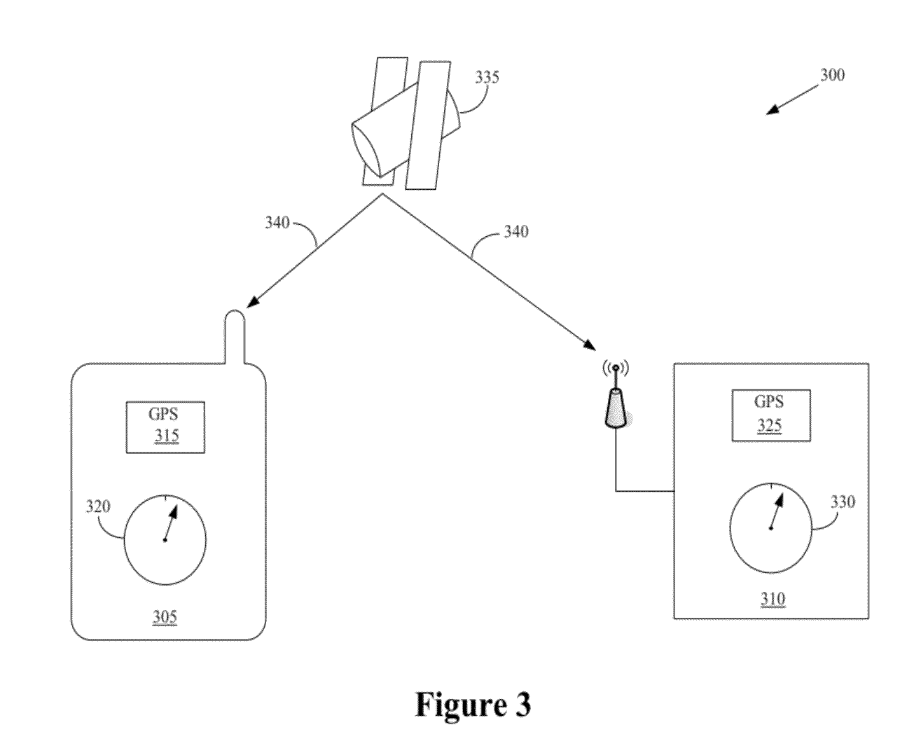

FIG. 3 conceptually illustrates a second exemplary embodiment of a wireless communication system 300. In the illustrated embodiment, the wireless communication system 300 includes a mobile node 305 and a base station 310 that may be the serving base station for the mobile mode 305. The mobile node 305 includes GPS functionality 315 and an internal clock 320. The base station 310 also includes GPS functionality 325 and an internal clock 330. The entities in the wireless communication system 300 are synchronized to a global timing reference provided by GPS satellites 335 that broadcast GPS signals 340. Although a single GPS satellite 335 is shown in FIG. 3, persons of ordinary skill in the art should appreciate that a GPS system includes numerous satellites and entities in the wireless communication system 300 typically acquire signals from two or more GPS satellites 335 to determine their locations and/or timing references.

The base station 310 may remain substantially continuously synchronized with the global timing reference provided by the GPS system so that the internal clock 330 is locked to the global timing reference. However, synchronizing the internal clock 320 to the global timing reference provided by the GPS system may require powering up the GPS functionality 315, acquiring signals 340 provided by several GPS satellites 335, and performing the clock synchronization before powering down the GPS functionality 315. If the GPS is turned on frequently, this procedure can consume a significant amount of battery power and consequently reduce the operating time of the mobile node 305. At least in part to conserve battery power, the mobile node 305 may synchronize the internal clock 320 to the global timing reference at selected time intervals that may be many orders of magnitude longer than the clock period determined by the clock frequency. The mobile node 305 can synchronize to a global timing reference by system time calibration from the attached GPS receiver (functionality) 315. To obtain the GPS time that is used as the global system time, the GPS functionality 315 only needs to acquire the GPS signals from two satellites. On the other hand, signals from at least 4 satellites have to be acquired by the GPS functionality 315 to perform the location estimation. Consequently, when the mobile node 305 only uses the GPS functionality 315 to track timing (and not to determine its location), the GPS functionality 315 in the mobile node 305 consumes less power than would be consumed if the mobile node 305 used the GPS functionality 315 to perform a complete location estimation. Therefore, relative to mobile nodes that use their internal GPS functionality to calculate their location, embodiments of the mobile node 305 may save a significant amount of power by restricting use of the GPS functionality 315 to infrequent calibration of the internal system time of the mobile node 305.

In the illustrated embodiment, the internal clock 320 is synchronized to the global timing reference at time intervals that are determined by the drift speed of the internal clock 320 and a target distance measurement error. For example, the clock frequency drift may be approximately 100 ppb (parts per billion) per Celsius degree of temperature change. Persons of ordinary skill in the art having benefit of the present disclosure should appreciate that the drift speed of a clock depends on the clock design, the precise structure of the actual clock, the temperature range, and other variables. The term “approximately” is intended to encompass these expected clock-to-clock variations in the drift speed. A typical rate for temperature change experienced by a mobile node 305 may be less than or on the order of 1 degree Celsius per hour, which would result in approximately 100 ppb frequency drift per hour due to the temperature change. A frequency drift of this magnitude translates to a timing drift of approximately 10̂-7 second per hour, which equates (using the signal propagation speed) to a distance measurement error of approximately 30 m per hour or 0.5 m per minute. Synchronizing the internal clock 320 every 10 minutes may therefore be able to maintain the maximum distance measurement error at or below approximately 5 m. This may be sufficient for the mobile node 305 since a reasonable estimate of the walking speed of a pedestrian is approximately 3 km/h=50 m/min.

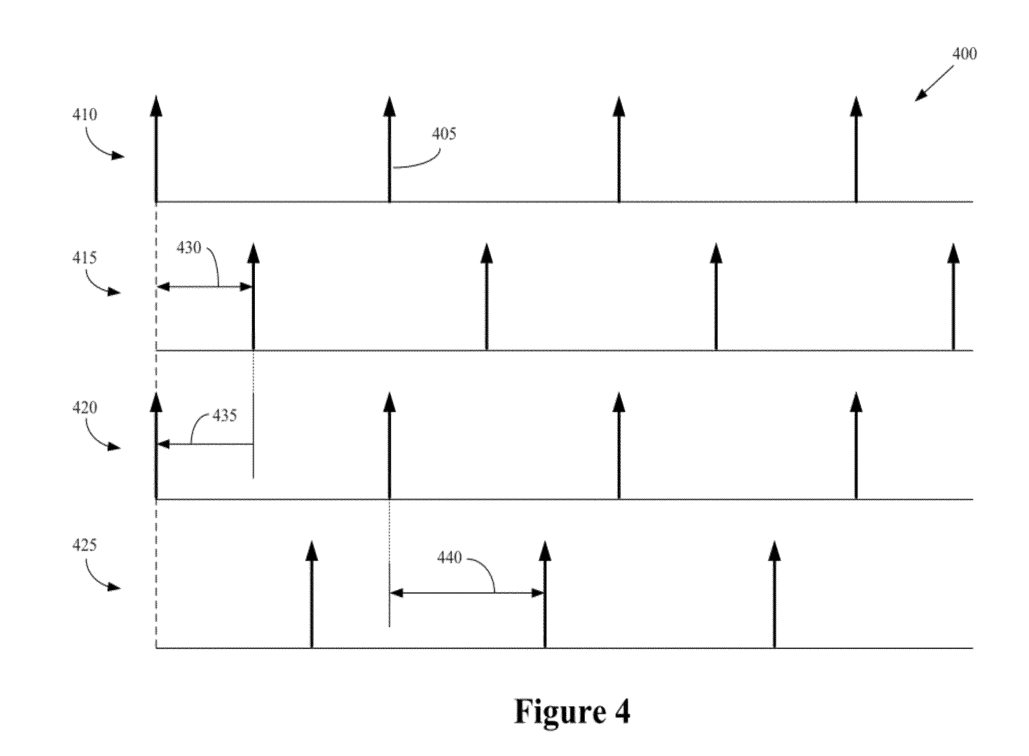

FIG. 4 conceptually illustrates one exemplary embodiment of a timing diagram 400. In the illustrated embodiment, reference timing signal boundaries are indicated by the arrows 405. In the interest of clarity only one arrow 405 is specifically indicated by a numeral in FIG. 4. The reference timing signal boundaries 405 can be defined in a variety of ways. For example, the reference timing signal boundaries 405 can be defined in terms of a frame structure, a subframe structure, a time-division multiplexing (TDM) slot, and the like. The reference timing signal boundaries 405 can be detected in received signals using a variety of well known techniques. For example, a receiver can detect a reference timing signal boundaries 405 using a RAKE receiver that monitors a down link pilot signals modulated with the orthogonal codes. The RAKE receiver correlates the received signals to known orthogonal codes. Peaks in the correlation function indicate arrival times of the orthogonal codes. However, persons of ordinary skill in the art should appreciate that other techniques can be used to detect the reference timing signal boundaries 405.

The timing diagram 400 illustrates the global system timing reference 410, the local system timing 415 tracked by the mobile node, the global system timing reference 420 maintained at the mobile node, and pilot signal timing boundaries 425 received at the mobile node from a neighboring base station. The global system timing reference 410 may correspond to a GPS timing reference or some other external timing reference that is used by base stations to coordinate transmission and/or reception of signals. The local system timing 415 is offset from the global system timing reference 410 by a timing offset 430 caused the one-way delay for signals transmitted from a serving base station to the mobile node. In the illustrated embodiment, the mobile node can recover and/or maintain the global system timing reference 420 by shifting or correcting the local system timing 415 using the timing offset 430, as indicated by the arrow 435. For example, the mobile node may receive signals indicating the one-way delay measured by the serving base station using signals received from the mobile node. For another example, the mobile node may shift or correct the local system timing 415 using global system timing provided by a GPS system.

The mobile node can determine the distance between the mobile node and the base station by comparing the locally-maintained global system timing reference 420 to the timing boundaries 425 of signals such as the pilot signal transmitted from the neighboring base station. In the illustrated embodiment, the comparison reveals that the timing boundaries 425 are delayed relative to the locally-maintained global system timing reference 420 by a delay 440. The distance between the mobile node and the neighboring base station is equal to the delay 440 multiplied by the propagation speed of the signal transmitted by the neighboring base station. The mobile node can therefore determine the distance directly from the comparison of the timing reference 420 and the timing boundaries 425 without using any additional signaling between the mobile node and the neighboring base station. Since the base stations in the communication system are synchronized to the global system timing reference 410, the same approach can be used to determine distances to any neighboring base station.

Referring back to FIG. 2, the mobile node 205 can determine the distances 215 to the base stations 210 using embodiments of the techniques described herein. For example, the mobile node 205 can determine the one-way delays (OWD11, OWD12, OWD13) for signals transmitted from the base stations 210 and received at the mobile node 205. The distances can then be calculated using the radiofrequency propagation speed:

DIST11=RF propagation speed×OWD11

DIST12=RF propagation speed×OWD12

DIST13=RF propagation speed ×OWD13

The locations (aᵢ,bᵢ) of the base stations 210 are also provided to the mobile node 205. For example, a serving base station 210 may provide a list of the base stations 210 that neighbor the mobile node 205 and their coordinates to the mobile node 205 by broadcasting the coordinates and identities of the neighbor base stations. Alternatively, the location information can be provided to the mobile node 205 using dedicated signaling if mobile node 205 has an active connection. The locations and the identities of the neighbor base stations 210 are not likely to change rapidly and so this overhead signaling may be provided relatively infrequently, e.g., at intervals on the scale of minutes, hours, or even days depending on how widely, rapidly, and/or frequently the mobile node 205 moves. The locations and the distances can then be used to determine the location of the mobile node 205 using trilateration equations:

(x1−a1)̂2+(y1−b1)̂2=DIST11̂2

(x1−a2)̂2+(y1−b2)̂2=DIST12̂2

(x1−a3)̂2+(y1−b3)̂2=DIST13̂2

The number of base station distances and locations needed to determine the location of the mobile node 205 can vary depending on the particular circumstances. A minimum of two distances/locations may be needed to determine the location of the mobile node 205. However, since the measured distance only defines a circle about the location of the base station 210 and the intersection of two circles is two points, a third distance/location may be used to break the degeneracy between the two points defined by the intersection of the two circles. In one embodiment, the mobile node 205 can select the base stations 210 that are used to determine the location of the mobile node 205. For example, the mobile node 205 may select two or three or more base stations 210 from a larger set of neighbor base stations based on the received signal strengths, e.g., the mobile node 205 may select the three base stations 210 that have the highest received signal strengths.

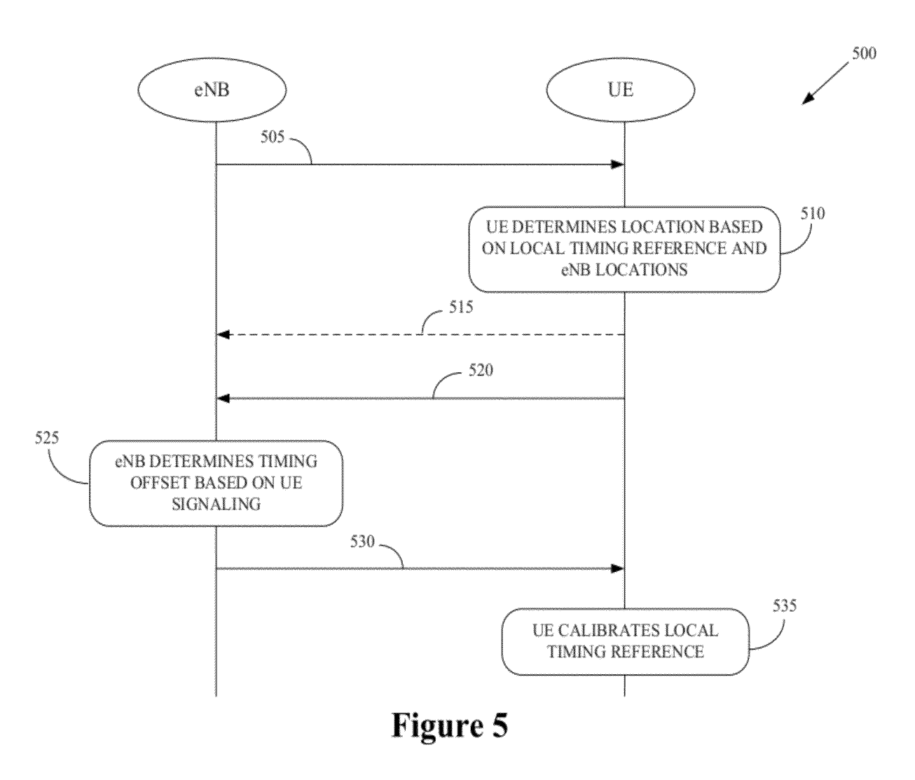

FIG. 5 conceptually illustrates one exemplary embodiment of a method 500 for determining a location of a mobile node. In the illustrated embodiment, the mobile node or user equipment (UE) is in communication with one or more base stations or eNodeBs (eNB). The serving base station initially provides (at 505) locations of neighboring base stations to the mobile node. The location information can be provided (at 505) by broadcasting or unicasting the location information. The mobile node is maintaining a local system time reference and so the mobile node can determine (at 510) its location using the received base station location information and delays between the local system time reference and the timing of signals received from the serving base station and any other neighboring base stations. The mobile node can optionally report (at 515) this information to the base station, e.g., in response to a request from the network.

In the illustrated embodiment, the mobile node may request (at 520) reference timing information to correct or calibrate the locally-maintained global system timing reference. In response to the request, the base station can measure (at 525) a timing offset using signals received from the mobile node. The timing offset corresponds to the one-way delay (OWD_serving) from the serving base station to the mobile node. The base station can then transmit (at 530) information indicating the timing offset to the mobile node so that the mobile node can correct or calibrate (at 535) the locally-maintained global system timing reference. For example, the mobile node may be tracking and be synchronized with the received signal from the serving base station so that the mobile node can obtain the macro system timing by shifting or correcting (at 535) the local reference in lock by the value of OWD_serving received from the base station.

Alternatively, if the system time is synchronized to GPS timing and the mobile node includes GPS functionality, the mobile node's local system time could be obtained and calibrated directly from the GPS system. This approach would only require relatively infrequent use of the mobile mode's GPS receiver and other GPS functionality only for local system time calibration. In contrast, relatively frequent location estimation and/or speed estimation may be performed using the locally-maintained global system timing reference, which significantly reduces the power consumption by the GPS functionality while also providing accurate position determinations. In one embodiment, the OWD may initially be received from the serving base station to allow the mobile node to develop the association between the macro system timing and GPS timing reference. The location estimation error is normally accumulated over time and is biased towards one direction due to the system bias on timing offset measurement and the local reference clock drifting.

Embodiments of the low-cost, low power consumption location determination technique described herein may enable a mobile node to make more frequent location determinations. This can facilitate transport functionality that would be impractical or impossible if mobile nodes that implement location determination technique that have lower accuracy and/or higher power consumption. For example, a mobile node can use frequent location determinations to make significantly more accurate speed estimations. The current speed can be estimated by making multiple location estimations within short periods of time. In one embodiment, accurate location estimations may preferentially be performed right after the calibration. For speed estimation, if the location samples are taken between short periods of time, the system bias and accumulated clock drifting error can be canceled. The impact of the clock drift on the speed estimation is less than the location estimation.

Small cells such as femtocells are typically private so that the owner's mobile node(s) could memorize the locations of a few its own femto cells. However, when the small cell is a public small cell, the mobile node(s) that may attempt to access the public cells are not expected to be able to store the locations of all of the potentially available small cells. Moreover, the base stations don't like to broadcast a long list of their locations. In some embodiments, frequent location determinations can therefore be used to map locations of public small cells (such as microcells, picocells, femtocells, and the like) that overlay other cells. This information can then be used to generate maps of the public small cells that overlay a macro-cellular deployment. The public small cell maps can be transmitted or broadcast to mobile nodes so that the mobile nodes may be able to decide when they should search for the public small cell signals and when they should conserve power by turning off their femtocell reception functionality.

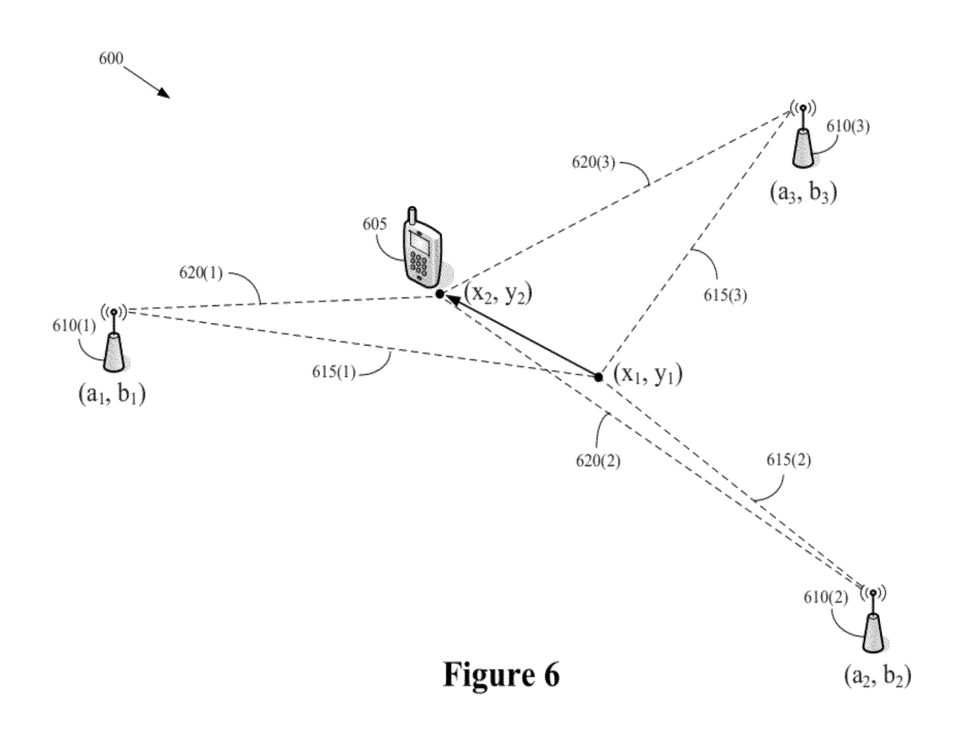

FIG. 6 conceptually illustrates a third exemplary embodiment of a wireless communication system 600. In the illustrated embodiment, locations (aᵢ,bᵢ) of base stations 610 are provided to a mobile node 605. At a first time T₁, the mobile node 605 can determine distances 615 to the base stations 610 using embodiments of the techniques described herein. For example, the mobile node 605 can determine the one-way delays (OWD11, OWD12, OWD13) for signals transmitted from the base stations 610 and received at the mobile node 605 and the distances can be calculated using the radiofrequency propagation speed. The locations and the distances can then be used to determine the location (x₁, y₁) of the mobile node 605 using trilateration equations. At a second time T₂ subsequent to the first time, the mobile node 605 can determine new distances 620 to the base station 610 using embodiments of the techniques described herein. The locations and the distances can then be used to determine the subsequent location (x₂, y₂) of the mobile node 605 using trilateration equations. The mobile node 605 can use this information to estimate its current speed as:

$$s = \frac{\sqrt{{( {x}_{2} - {x}_{1} )}^{2} + {( {y}_{2} - {y}_{1} )}^{2}}}{{T}_{2} - {T}_{1}}$$

In one embodiment, the mobile node 605 can also calculate its velocity (e.g., its speed and direction, which may be represented as a vector, \vec{s}, that has a magnitude: s=|\vec{s}|) using well known techniques. In alternative embodiments, multiple location estimation samples can be gathered and statistically combined (e.g., averaged) to improve the accuracy of the location and/or speed estimations, as well as providing information indicating the likely errors and/or standard deviation of the estimations.

In one embodiment, estimates of the speed performed according to embodiments of the techniques described herein may be used to define scaling factors for the handoff hysteresis used by the mobile node 605. For example, the scaling factor may be defined as a substantially continuous function of the speed: K_sc=F(Speed_uc) such as a linear function or some other continuous function. Alternatively, the scaling factor may be used to categorize the speed of the mobile node but the granularity of the categories may be increased (relative to the conventional high, medium, and low speed categories) to reflect the improved accuracy of the speed estimation.

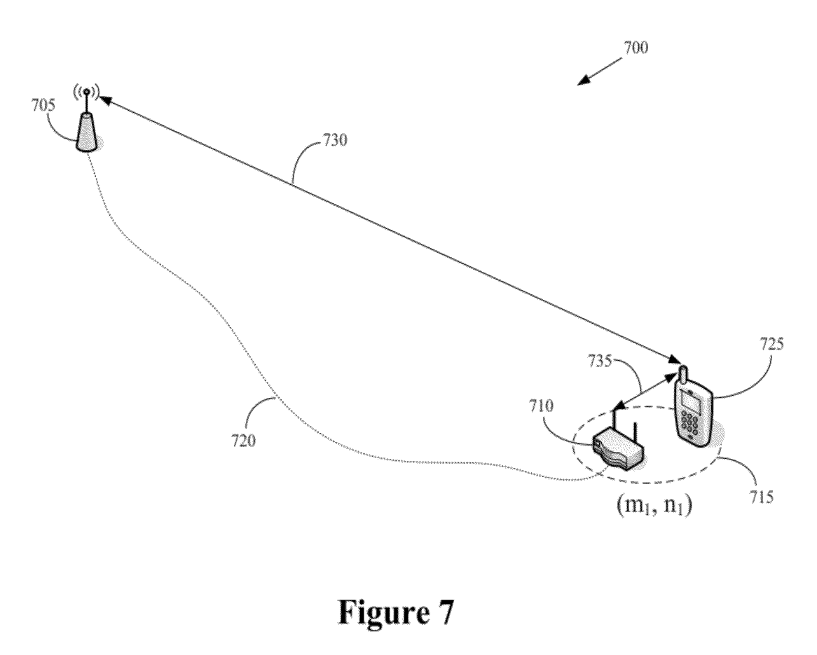

FIG. 7 conceptually illustrates a fourth exemplary embodiment of a wireless communication system 700. In the illustrated embodiment, the wireless communication system 700 is part of a heterogeneous network that includes a macro-cellular base station 705 and one or more femtocells 710 that provide wireless connectivity in microcells 715 that overlay the macro-cellular deployment. In one embodiment, the base station 705 and the femtocell 710 may be connected by a wired and/or wireless interface 720. A mobile node 725 is able to communicate with the base station 705 over an air interface 730 and to communicate with the femtocell 710 over an air interface 735. Persons of ordinary skill in the art should appreciate that the terms microcell, femtocell, picocell, and the like typically refer to the size of the coverage area provided by the associated access point or base station. The functionality of the access point, base station, or base station router that provides wireless connectivity within these areas may be similar.

In a heterogeneous network (HetNet) such as shown in FIG. 7, the macro-cellular coverage may be overlapped with the femtocell coverage, e.g., in residential areas. Most of the femtocells and/or some public picocells are typically deployed in an indoor environment and consequently it may be difficult for the network and/or the indoor femtocells to determine the location of the indoor femtocells. For example, small cells (such as femtocells and/or picocells) that are deployed indoors may not be able to acquire a sufficient number of GPS satellite signals to provide accurate location determination, at least in part because the strength of the GPS signals indoor is typically 30 dB lower than the measured outdoor strength of the GPS signals at the same location. Furthermore, due to cost constraints many femtocells may not even have a GPS receiver installed. However, many applications require that the network know the location of the femtocell, e.g., to support important applications such as the emergency service E911. Femtocell location information may also be used to support system performance improvement or optimization. For example, location information can be used to perform a location based search for power saving possibilities or location based power control for interference mitigation.

Embodiments of the location determination technique described herein can be used to support a mobile-assisted technique for determining the location of microcells such as femtocells and/or picocells. In one embodiment, locations (m₁, n₁) of femtocells 710 can be determined as follows:
1. A femtocell calibration mode is enabled and the mobile node 725 monitors the power/signal strength for the femtocell 710.
2. When the mobile node 725 determines that the signal strength for the femtocell 710 is over a threshold, indicating that the location and the one way delay to the macrocell 705 of the mobile node 725 is approximately equal to the location and the one way delay of the femtocell 710, the mobile node 725 may determine and report its location, e.g., the location may be reported as part of a power measurement report that is transmitted to the network. The serving macrocell of the network may also be notified or informed of the one way delay from the base station 705 to the mobile node 725.
3. In one embodiment, the mobile node 725 reports the location information to the femtocell 710. The femtocell 710 may then forward the information to the network, e.g., over the interface 720 to the base station 705.
4. In alternative embodiments, the mobile node 725 reports the location information and the associated femtocell identifier to the overlaid macro cell 705. The macro cell 705 may then forward the location information and the macro-to-femto one way delay to the network and/or the femtocell 710.
5. In either case, the femtocell 710 becomes aware of its estimated location and can subsequently broadcast this information for use by other mobile nodes.
6. In one embodiment, the location information could help the associated mobile node 725 build a “fingerprint” of the overlaid microcells. The mobile node 725 may then refrain from searching for micro-cellular coverage until it determines that is proximate to the fingerprint of overlaid microcells.

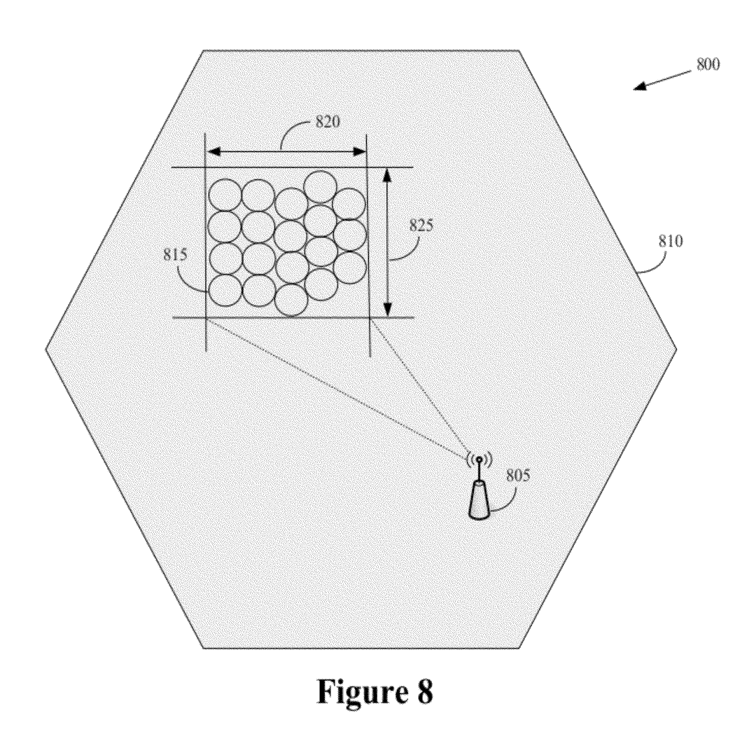

FIG. 8 conceptually illustrates a fifth exemplary embodiment of a wireless communication system 800. In the illustrated embodiment, the wireless communication system 800 is part of a heterogeneous network that includes a macro-cellular base station 805 that provides wireless connectivity to a macrocell 810. The network also includes a cluster of campus-CSG cells/picocells that provide wireless connectivity in microcells 815 that overlay the macro-cellular deployment. When the cluster includes a large number of microcells 815 such as public pico cells and campus CSG cells, a mobile node may not be able to build a radio fingerprint for all the microcells 815. Mobile nodes can locate the microcells 815 using a global search, but the search would have to be performed substantially continuously, even in regions that do not include any micro-cells. In one embodiment, the base station 805 may broadcast a signal or message to indicate whether there any micro-cells are overlaid with the macro-cell 810. Mobile nodes may then only search for micro-cells when they receive a positive indication that micro-cells are present in the macro-cell 801, which may save battery power in the mobile node.

To further save mobile power, alternative embodiments of the base station 801 may broadcast information indicating the locations of the pico-cells 815. Mobile nodes may then search for micro-cells when they receive an indication that they are proximate one or more micro-cells 815. The mobile node may determine its proximity to the cells 815 by comparing the location information to its internally determined location, as discussed herein. However if there are too many pico-cells 815, broadcasting all of their individual locations may be costly in terms of air interface overhead. The base station 805 may therefore broadcast information indicating the range of the coverage area(s) of the micro-cells 815. For example, the base station 805 may broadcast information indicating a longitude range 820 and a latitude range 825 of the coverage area(s). In this embodiment, location-aware mobile nodes may start to search for the micro-cells 815 when they determine that they are proximate to and/or within the coverage area defined by the longitude range 820 and latitude range 825.

In one exemplary embodiment, the base station 805 may learn and broadcast picocell location information as follows:

1. Base stations 805 in each macrocell 810 may broadcast information indicating whether picocells 815 are deployed overlapping the macrocell 810, e.g. the base station 805 may broadcast ‘1’ to indicate that picocells are overlaid with the cell and the base station 805 may broadcast ‘0’ to indicate that no picocells are overlaid with the macrocell 810. If a mobile node sees the indicator is set to ‘1’, the mobile node may start to search for picocells 815 in the macrocell 810. If a mobile node sees the indicator is set to ‘0’, the mobile node does not initiate or perform a search. If the indicator is not present in any broadcast messages, the mobile node can optionally search with a longer DRX (or searching) cycle.

2. Alternatively, the base station 805 in the macro cell 810 that is overlaid with picocells 815 may broadcast location information of the picocells 815 to support power saving in the mobile node.

3. If there are a large number of picocells 815 within a particular coverage area, the base station 805 in the overlaid macrocell 810 may broadcast information indicating the range or boundaries that encompass the combined coverage area of the picocells 815.

4. When the mobile node moves into the macrocell 810 that is broadcasting picocell location information, the mobile node may begin to monitor its location more frequently to determine whether it is proximate or within the coverage area of one or more of the picocells 815.

5. When the mobile node determines that it is proximate or within the coverage area of one or more of the picocells 815, the mobile node may begin a search and acquisition process to identify the picocells 115 and potentially handoff to one of the picocells 815.

6. For mobile nodes that don't have the capability to detect their location, the presence of the picocell location information may serve as an indication of existence of the picocells 815 in the macro cell 810.

Portions of the disclosed subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the disclosed subject matter are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The disclosed subject matter is not limited by these aspects of any given implementation.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed:

1. A method, comprising:
comparing, at a mobile node, a global system timing reference locally maintained by the mobile node to arrival times of signals transmitted by at least two base stations to determine at least two distances between the mobile node and said at least two base stations; and
determining, at the mobile node, a location of the mobile node using said at least two distances and locations of said at least two base stations.

2. The method of claim 1, wherein determining the location of the mobile node comprises using trilateration to determine the location of the mobile node using said at least two distances and the locations of said at least two base stations.

3. The method of claim 1, comprising receiving information indicating the locations of said at least two base stations from one of said at least two base stations, wherein said information is broadcast by one of said at least two base stations.

4. The method of claim 1, comprising synchronizing the locally-maintained global timing reference to a global timing reference used to coordinate signals transmitted by said at least two base stations, wherein the locally-maintained global timing reference is synchronized to the global timing reference at intervals defined by a drift speed of the local timing reference and a distance measurement error.

5. The method of claim 4, wherein synchronizing the locally-maintained global timing reference to the global timing reference comprises synchronizing the locally-maintained global timing reference using a timing offset determined by a serving base station using signals received from the mobile node.

6. The method of claim 4, wherein synchronizing the locally-maintained global timing reference to the global timing reference comprises synchronizing the locally-maintained global timing reference to a timing reference signal provided by a global positioning system.

7. The method of claim 1, comprising determining at least one speed of the mobile node using at least two locations of the mobile node that are determined at times separated by a selected time interval, wherein said at least two locations of the mobile node are each determined using at least two distances between the mobile node and at least two base stations and at least two locations of said at least two base stations.

8. The method of claim 7, comprising determining a scaling factor for a handoff hysteresis used by the mobile node, wherein the scaling factor is determined as a substantially continuous function of said at least one speed.

9. The method of claim 1, comprising transmitting, from the mobile node, information indicating the location of the mobile node and an identifier of a femtocell, wherein said information is transmitted in response to determining, at the mobile node, that a signal strength from the femtocell has increased above a predetermined threshold.

10. The method of claim 9, wherein said information is transmitted to at least one of the femtocell or one of said at least two base stations to indicate the location of the femtocell.

11. The method of claim 9, comprising receiving, at the mobile node, information indicating locations of at least one femtocell, wherein said information is broadcast by one of said at least two base stations.

12. A method, comprising:
providing, from a base station in response to a request from a mobile node, a timing offset defined to synchronize a global timing reference maintained locally by the mobile node to a global timing reference used to transmit signals from the base station, wherein the mobile node is configured to compare the locally-maintained global timing reference to arrival times of signals transmitted by the base station and at least one other base station to determine at least two distances between the mobile node and the base stations and thereby determine a location of the mobile node using said at least two distances and locations of the base stations.

13. The method of claim 12, comprising providing, from the base station, information indicating the locations of the base station and said at least one other base station.

14. The method of claim 12, comprising receiving, from the mobile node, information indicating the location of the mobile node and an identifier of at least one femtocell, wherein said information is transmitted in response to determining, at the mobile node, that a signal strength from said at least one femtocell has increased above a predetermined threshold.

15. The method of claim 14, comprising storing information associating the location of the mobile node with at least one location of said at least one femtocell.

16. The method of claim 15, comprising broadcasting information indicating said at least one location of said at least one femtocell.

17. The method of claim 16, wherein broadcasting said information comprises broadcasting information indicating a latitude range and a longitude range that encompasses at least one of a micro-cell, a pico-cell, or said at least one femtocell.

18. A method, comprising:
storing, at a femtocell, information indicating the location of the femtocell, wherein said information is determined by a mobile node in response to the mobile node determining that a signal strength transmitted by the femtocell is above a predetermined threshold, and wherein the location of the femtocell is determined by a location determined by the mobile node using locations of at least two base stations and at least two distances between the mobile node and said at least two base stations, and wherein said at least two distances are determined by comparing, at the mobile node, a global system timing reference maintained locally by the mobile node to arrival times of signals transmitted by said at least two base stations.

19. The method of claim 18, further comprising receiving, at the femtocell and from a serving base station, said information indicating the location of the femtocell.

20. The method of claim 19, wherein storing said information indicating the location of the femtocell comprises information indicating the location of the mobile node and information indicating a one-way delay between the serving base station and the femtocell.
